(19) United States
(12) Patent Application Publication
(10) Pub. No.: US 2016/0036029 A1
(43) Pub. Date: Feb. 4, 2016

(54) POWER SOURCE PACK

(71) Applicant: GS Yuasa International Ltd., Kyoto-shi (JP)

(72) Inventor: Masamitsu TONONISHI, Kyoto-shi (JP)

(21) Appl. No.: 14/806,529

(22) Filed: Jul. 22, 2015

(30) Foreign Application Priority Data
Jul. 31, 2014 (JP) 2014-157239

(51) Int. Cl. H01M 2/20; H01M 2/02

(52) U.S. Cl. CPC H01M 2/206; H01M 2/0237; H01M 2220/20

(57) ABSTRACT

A power source pack includes: a housing formed of a container body and a lid portion; a cell stack housed in the housing, the cell stack including a battery; a first electrical component subunit electrically connected to the cell stack, the first electrical component subunit including a first electrical component such as a relay; and a second electrical component subunit electrically connected to the first electrical component subunit, the second electrical component subunit including a second electrical component such as a BMU. The cell stack, the first electrical component subunit and the second electrical component subunit are stacked in a first direction.

### CROSS-REFERENCE TO RELATED APPLICATIONS

This application claims the benefit of Japanese patent application No. 2014-157239, filed on Jul. 31, 2014, which is incorporated by reference.

### FIELD

The present invention relates to a power source pack using energy storage devices such as secondary batteries, for example.

### BACKGROUND

A secondary battery has been popularly used as a power source for electronic equipment such as a mobile phone or IT equipment in addition to an application where a primary battery is replaced with a secondary battery. Particularly, a nonaqueous electrolyte secondary battery represented by a lithium ion secondary battery possesses high energy density and hence, the application of the nonaqueous electrolyte secondary battery to electrical equipment such as an electric vehicle has been in progress. In this case, the secondary battery is typically used in the form of a power source module aiming at the acquisition of a high output and a large capacity.

The power source module is configured such that a cell stack in which a plurality of secondary batteries (cells) are arranged in a row is housed in a housing. Electrode terminals of the respective batteries are connected to each other in the cell stack and hence, the power source module functions as one power source pack having a high voltage and a large capacity (see

However, the conventional power source pack has the following drawback. That is, to make such a power source module operate as one power source pack, it is necessary to assemble a BMU (Battery Management Unit) which controls charging and discharging and other electrical components into the housing together with the cell stack. However, the arrangement of the electrical components is restricted by shapes, sizes and the like of the housing and the cell stack and hence, the assembling of these electrical components has resulted in lowering productivity of the power source packs.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

An object of the present invention to provide a power source pack which can increase productivity thereof.

An aspect of the present invention is directed to a power source pack which includes: a housing; a cell stack housed in the housing, the cell stack including an energy storage device; a first subunit electrically connected to the cell stack, the first subunit including a first electrical component; and a second subunit electrically connected to the first subunit, the second subunit including a second electrical component, wherein the cell stack, the first subunit and the second subunit are stacked in a first direction.

### BRIEF DESCRIPTION OF DRAWINGS

The foregoing and other features of the present invention will become apparent from the following description and drawings of an illustrative embodiment of the invention in which:

FIG. 1 is a perspective view showing a configuration of a power source pack of a first embodiment of the present invention.

FIG. 2 is an exploded perspective view showing the configuration of the power source pack.

FIG. 3 is an exploded perspective view showing part of the power source pack.

FIG. 4 is an exploded perspective view showing part of the power source pack.

FIG. 5 is an exploded perspective view showing part of the power source pack.

FIG. 6 is a cross-sectional view showing part of the power source pack.

FIG. 7 is a block diagram showing an electrical configuration of the power source pack.

FIG. 8 is a perspective view showing part of a power source pack of a second embodiment of the present invention.

FIG. 9A is a cross-sectional view showing part of the power source pack.

FIG. 9B is a cross-sectional view showing part of the power source pack.

### DESCRIPTION OF EMBODIMENTS

An aspect of the present invention is directed to a power source pack which includes: a housing; a cell stack housed in the housing, the cell stack including an energy storage device; a first subunit electrically connected to the cell stack, the first subunit including a first electrical component; and a second subunit electrically connected to the first subunit, the second subunit including a second electrical component, wherein the cell stack, the first subunit and the second subunit are stacked in a first direction.

The first electrical component may have higher heat resistance than the second electrical component.

The housing may include a lid portion in which the second subunit is accommodated, and a housing body in which the cell stack and the first subunit are accommodated, and a portion of the lid portion may be detachable from remaining portions of the lid portion.

The power source pack may include a connector connected to at least either one of the first subunit or the second subunit, and the connector may be embedded in the housing.

Further, the first electrical component may be at least any one of a relay, a resistor and a bus bar.

The aspects of the present invention having the above-mentioned configuration has an advantageous effect that productivity of power source packs can be enhanced.

### First Embodiment

(1. Power Source Pack)

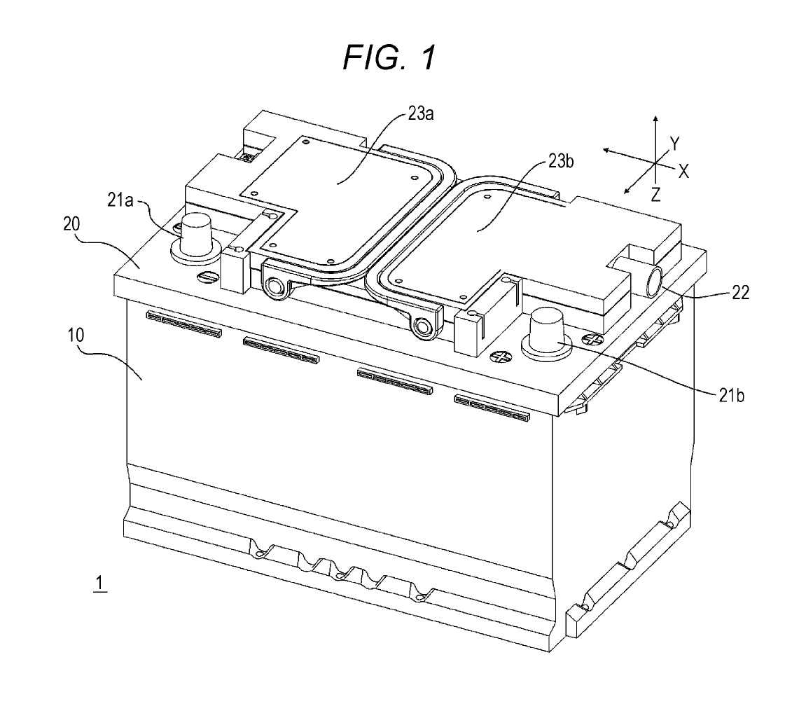

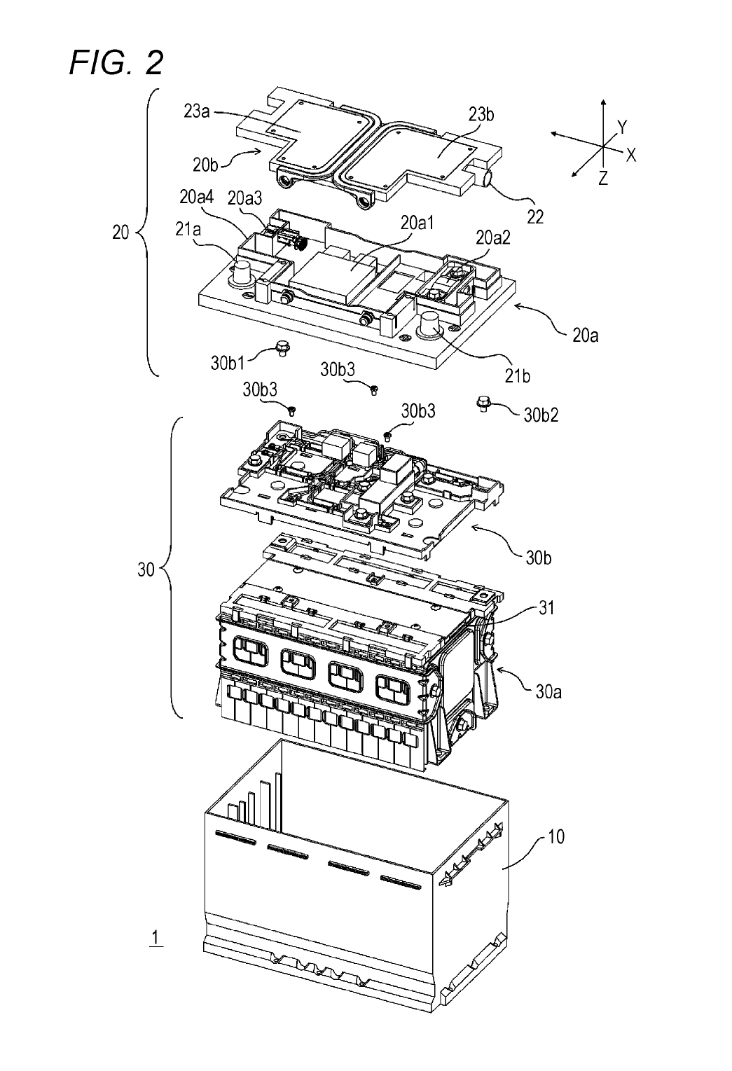

FIG. 1 is a perspective view showing the configuration of a power source pack 1 according to a first embodiment of the present invention, and FIG. 2 is a perspective view, with a part exploded, schematically showing the power source pack 1.

As shown in FIG. 1, the power source pack 1 includes a housing having a hexahedral shape constituted of an open box-shaped container body 10 and a lid portion 20 which are made of a synthetic resin such as polypropylene. The power source pack 1 also includes; a negative electrode terminal 21a and a positive electrode terminal 21b which are exposed from an upper surface of the lid portion 20 and are connected to an external load not shown in the drawing; and an exhaust sleeve 22 which communicates with an inner space of the housing.

As shown in FIG. 2, in the power source pack 1, a power source module body 30 described later is housed in the container body 10 of the housing. Exhaust ports 31 described later are formed in both side surfaces of the power source module body 30 respectively, and gas generated from a cell stack formed by arranging a plurality of batteries is discharged through the exhaust ports 31. The whole housing has airtightness so that gas discharged through the exhaust ports 31 stays in the housing and, thereafter, is discharged to the outside the power source pack 1 through the exhaust sleeve 22 of the lid portion 20.

A first electrical component subunit 30b described later is arranged on an outermost layer of the power source module body 30 at a position which faces the lid portion 20 in an opposed manner.

Assume that the arrangement direction of batteries in the cell stack of the power source module body is aligned with a straight line which is parallel to an X axis of an orthogonal coordinate system consisting of the X axis, a Y axis and a Z axis shown in FIG. 1. Also assume that the respective surfaces of the housing, the power source module body 30 and the like which form the power source pack 1 are positioned approximately parallel to the X axis, the Y axis and the Z axis respectively. Still further, in the description made hereinafter, with respect to the directions indicated by arrows in the drawings, assume that the direction extending from a right side to a left side in the drawings is the X axis direction, the direction extending from a depth side to a front side in the drawings is the Y axis direction, and the direction extending from a lower side to an upper side in the drawings is the Z axis direction.

The lid portion 20 includes: a second electrical component subunit 20a which directly closes an opening of the container body 10 and mounts thereon electrical components which are arranged inside a partition wall 20a4 formed on an upper portion thereof; and an upper lid portion 20b which has a shape corresponding to a profile of the partition wall 20a4, covers the second electrical component subunit 20a and includes the exhaust sleeve 22. In the lid portion 20 having the above-mentioned configuration, the electrical components mounted on the second electrical component subunit 20a includes: a BMU (Battery Management Unit) 20a1 which controls charging and discharging of the power source pack 1, controls a state of the power source pack 1 such as a temperature of the power source pack 1, and enables the communication between the power source pack 1 and equipment to which the power source pack 1 is connected; a fuse 20a2 arranged on a power path of the power source pack; a communication connector 20a3 which enables communication such as the communication between the BMU 20a1 and equipment to which the power source pack 1 is connected; and other electrical components. A top plate of the upper lid portion 20b is configured to be detachable from the lid portion 20 as a panel 23a and a panel 23b.

The first electrical component subunit 30b disposed on one surface of the power source module body 30 and the second electrical component subunit 20a are electrically connected to each other by bolts and a harness described later which is mounted on the first electrical component subunit 30b.

(2. Power Source Module Body)

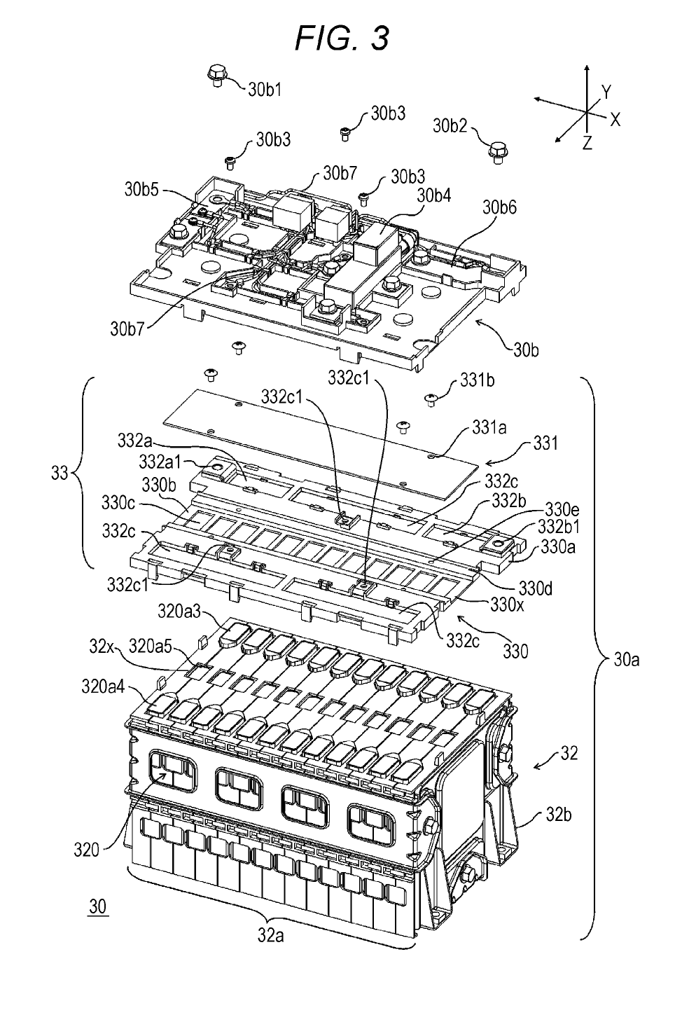

FIG. 3 is a perspective view, with a part exploded, schematically showing the configuration of the power source module body 30. As shown in FIG. 3, the power source module body 30 includes: a cell stack 32 formed by arranging and fastening batteries such as nonaqueous electrolyte secondary batteries to each other in a row; a bus bar assembly unit 33 for electrically connecting the respective batteries of the cell stack 32 to each other; and a first electrical component subunit 30b which is electrically connected with the bus bar assembly unit 33.

The cell stack 32 includes: a cell stack body 320 described later, in which the plurality of batteries are arranged in a row such that a negative electrode terminal 320a3, a positive electrode terminal 320a4 and a safety valve 320a5 are disposed on an upper surface of each battery; a cover 32a which covers surfaces of the cell stack body 320 and has an insulating property; and holders 32b which are mounted on the surface of the cell stack body 320 and a surface of the cover 32a, and maintain fixed shapes of these parts.

Openings for respectively exposing the electrode terminals 320a3, 320a4 and the safety valves 320a5 of the batteries to the outside are formed in an upper surface of the cover 32a. In the drawing, only openings 32x which expose the safety valves 320a5 are indicated by symbol.

The bus bar assembly unit 33 is a member made of a synthetic resin such as polypropylene having an insulating property and corrosion resistance against an electrolyte solution. The bus bar assembly unit 33 includes: a frame body 330a which conforms to a profile of an upper surface of the cell stack 32; and openings formed in the frame body 330a at positions corresponding to the electrode terminals 320a3, 320a4 and the safety valves 320a5 which are exposed from the cell stack 32. As a material for forming the frame body 330a, a synthetic resin such as a PBT resin having an insulating property and a heat resistant property may be used.

Sizes of the openings which are formed in the frame body 330a corresponding to the electrode terminals 320a3, 320a4 are set such that each opening extends between and over the electrodes arranged adjacent to each other in a straddling manner so as to control a connection pattern between electrode terminals corresponding to an electrical connection between the respective batteries. A metal bus bar 332a, a metal bus bar 332b and metal bus bars 332c which are connected to the electrode terminals 320a3 and the electrode terminals 320a4 are embedded in the openings respectively. The bus bar 332a and the bus bar 332b are used for connecting the terminals of the cell stack 32 to each other and for connecting the cell stack 32 to the electrode terminal 21a and the electrode terminal 21b of the power source pack 1, and the bus bars 332c are used for connecting the electrode terminals of the cell stack 32 to each other.

Openings 330c which correspond to the safety valves 320a5 are formed individually in accordance with the number of batteries which form the cell stack body 320.

A groove portion 330x is formed in the frame body 330a at a position which corresponds to the openings 330c, and the groove portion 330x has a two-stage step as viewed from a top surface of the frame body 330a, and both ends of the groove portion 330x reach both ends of the frame body 330a. The groove portion 330x is defined by: a lower stage surface 330b which extends along the arrangement direction of the safety valves 320a5 and in which the openings 330c are formed; and intermediate stage surfaces 330d which are formed along edges of the lower stage surface 330b.

As shown in FIG. 3, a heat insulator 331 is positioned above the groove portion 330x. The heat insulator 331 is a means which blocks heat radiated from the cell stack 32 thus reducing a thermal effect on the first electrical component subunit 30b and other electrical components positioned above the bus bar assembly unit 33. The heat insulator 331 also functions as a means which reinforces the power source module body 30. The heat insulator 331 is formed of a metal-made heat insulating body plate 331a having a rectangular shape corresponding to a profile of the groove portion 330x of the bus bar assembly unit 33, and is fitted in the intermediate stage surfaces 330d of the groove portion 330x.

The heat insulator 331 is fixed to the bus bar assembly unit 33 by threadedly engaging mounting screws 331b with mounting holes 330e formed in the frame body 330a of the bus bar assembly unit 33 through through-holes formed in a surface of the heat insulating body plate 331a.

Next, the configuration of the first electrical component subunit 30b is described. A base is made of a synthetic resin in the same manner as the frame body 330a of the bus bar assembly unit 33. On the base, as electrical components that form a power path through the bus bar 332a and the bus bar 332b, a relay 30b4 which opens/closes the power path, a resistor 30b5 formed of a shunt resistor or the like, and a bus bar 30b6 that is connected to the bus bar 332b and forms a part of a line are mounted. The first electrical component subunit 30b also includes, as electrical components, a harness 30b7 and the like which have one ends thereof connected to bus bars 332a, 332b and 332c mounted on the bus bar assembly unit 33 and the other ends thereof connected to the second electrical component subunit 20a.

The power path of the first electrical component subunit 30b and the power path of the bus bar assembly unit 33 are connected to each other by threadedly mounting bolts 30b1, 30b2 in mounting holes 332a1, 332b1 formed in the bus bars 332a, 332b respectively from an upper surface of the first electrical component subunit 30b. Further, the harnesses 30b7 of the first electrical component subunit 30b, which form signal paths, and the bus bar assembly unit 33 are connected to each other by threadedly mounting respective mounting bolts 30b3 in mounting holes 332c1 respectively formed in the bus bars 332c from the upper surface of the first electrical component subunit 30b.

(3. Cell Stack)

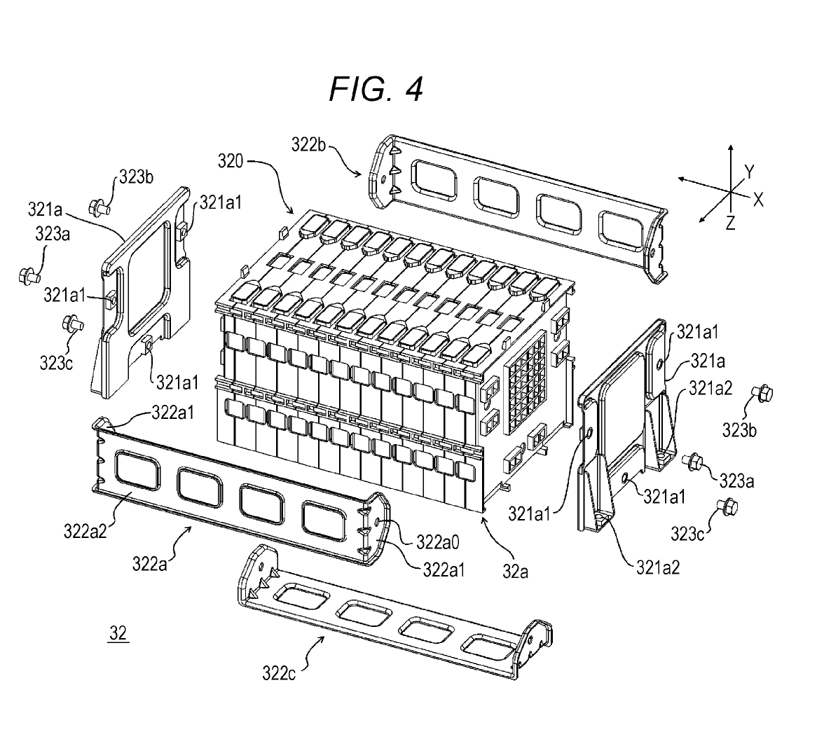

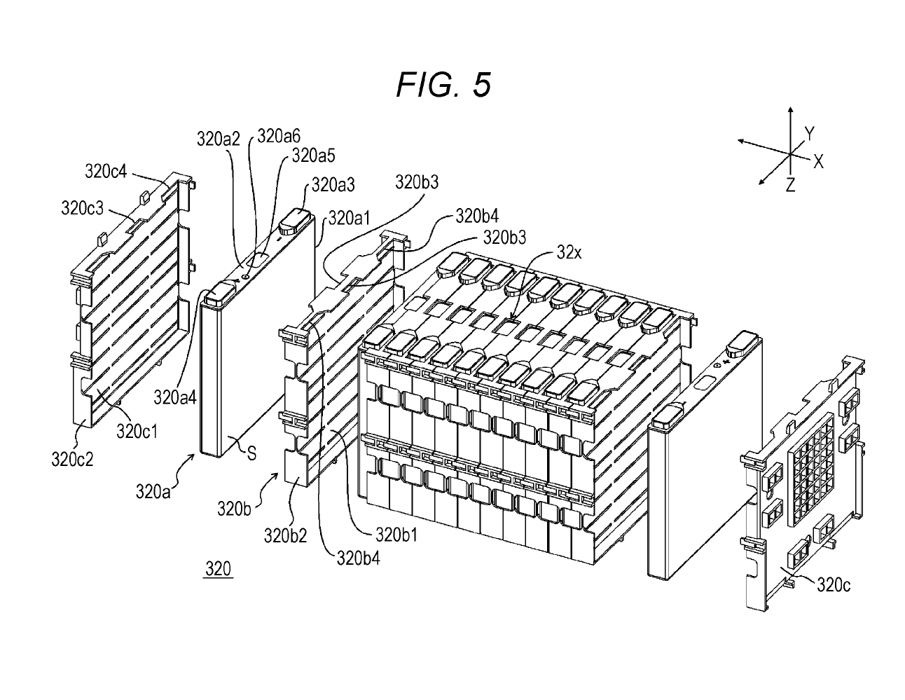

FIG. 4 is a perspective view showing the configuration of the cell stack 32 with the holder 32b in an exploded state, and FIG. 5 is a perspective view showing the cell stack body 320 in an exploded state.

As shown in FIG. 4, in the cell stack 32, the cell stack body 320 and the cover 32a which are integrally formed with each other are sandwiched by a pair of end plates 321a which is arranged at both ends of the cell stack body 320 in the arrangement direction of the batteries which form the cell stack body 320.

Using the arrangement direction of the batteries as an axis of symmetry, a stack bar 322a and a stack bar 322b are symmetrically arranged on side surfaces of the cell stack body 320 parallel to a Z⁻X plane in the drawing with respect to the axis of symmetry. A stack bar 322c is arranged below the axis. That is, the stack bar 322c is arranged on a bottom surface of the cell stack body 320 which is a plane parallel to a Y-X plane in the drawing.

The stack bars 322a to 322c have the same configuration. Hereinafter, the configuration of the stack bars 322a to 322c is described by taking the stack bar 322a as an example.

The stack bar 322a includes: a pair of flat-plate-shaped fastening portions 322a1 which faces the pair of end plates 321a in an opposed manner respectively; and an extending portion 322a2 which connects the fastening portions 322a1 to each other, and is formed along the arrangement direction of the batteries. A base material for forming the stack bar 322a is formed by applying press working to a steel plate or the like such that the base material for forming the stack bar 322a has an approximately U shape in cross section. A flange is formed on edges of the stack bar 322a respectively. As one example, the fastening portions 322a1 and the extending portion 322a2 are formed by bending a single base material.

The stack bar 322a and the end plates 321a are fixed to each other in such a manner that through-holes 322a0 formed in the fastening portions 322a1 are made to overlap with the mounting holes 321a1 formed in peripheral portions of the end plates 321a, and the stack bar 322a and the end plates 321a are fastened to each other by fastening bolts 323a. The fixing between stack bar 322b and the end plates 321a and the fixing between the stack bar 322c and the end plates 321a are performed in the same manner using fastening bolts 323b, 323c respectively.

Mounting holes 321a2 which open in the vertical direction are formed in a lower portion of the end plate 321a. Bolts 11 are inserted into the mounting holes 321a2 from the outside the housing, and are mounted in the mounting holes 321a2. The mounting holes 321a2 and the bolts 11 are used for fixing the power source module body 30 and the container body 10 of the housing to each other.

Next, each one of the plurality of batteries 320a which form the cell stack body 320 as shown in FIG. 5 includes: an open box-shaped outer covering body 320a1 which is made of metal such as aluminum or stainless steel, for example, and in which an electrode assembly and an electrolyte solution are sealed; and a lid portion 320a2 which is made of a material substantially equal to a material for forming the outer covering body 320a1 and closes an opening of the outer covering body 320a1 by being welded by laser welding or the like. The electrode terminal 320a3 and the electrode terminal 320a4, the safety valve 320a5 and a sealing plug 320a6 which seals an electrolyte solution filling port are mounted on the lid portion 320a2. The battery 320a has a flat angular columnar profile shape in which an upper surface and a lower surface of the battery 320a are formed of a top surface of the lid portion 320a2 and a bottom surface of the outer covering body 320a1 which is a surface on a side opposite to the top surface of the lid portion 320a2. In each battery 320a, a surface of the outer covering body 320a1 may be directly exposed, or side surfaces of the outer covering body 320a1 may be covered by an insulating film except for the bottom surface of the outer covering body 320a1.

Among all side surfaces of the battery 320a, the surface having the largest area is assumed as the main surface S. The cell stack body 320 is formed by arranging the batteries 320a such that the main surfaces S of the batteries 320a adjacently arranged face each other in an opposed manner with the spacer 320b interposed therebetween.

The spacer 320b is a member made of a material having an insulating property such as a synthetic resin. The spacer 320b includes: a main plate portion 320b1 which is sandwiched between the main surfaces S of the batteries 320a; and a side plate portion 320b2 which is formed on a peripheral portion of the main plate portion 320b1, projects to both sides in the arrangement direction of the batteries 320a, and covers the top surface of the lid portion 320a2 of the battery 320a and other side surfaces of the battery 320a. Notches are formed on the side plate portion 320b2. That is, the notch 320b3 is formed on a portion of the side plate portion 320b2 which overlaps with the safety valve 320a5 of the battery 320a, and the notches 320b4 are formed on portions of the side plate portion 320b2 which interfere with the electrode terminal 320a3 and the electrode terminal 320a4.

With such a configuration, in a state where the batteries 320a and the spacers 320b are arranged so as to form the cell stack body 320, the electrode terminals 320a3 and the electrode terminals 320a4 are exposed from the upper surface of the cell stack body 320. At the same time, a pair of notches 320b3 which face each other in an opposed manner forms the opening 32x thus exposing the safety valve 320a5 from the upper surface of the cell stack body 320.

Surfaces of the batteries 320a positioned at both ends of the cell stack body 320 are covered by spacers 320c each of which includes a main plate portion 320c1 having the same shape as the main plate portion 320b1 of the spacer 320b; and a side plate portion 320c2 which is formed in a projecting manner only in the direction that the spacer 320c faces the battery 320a. With respect to the batteries 320a at both ends of the cell stack body 320, the electrode terminal 320a3, the electrode terminal 320a4 and the safety valve 320a5 of each battery 320a are exposed from the upper surface of the cell stack body 320 through a notch 320c3 and notches 320c4 formed on the side plate portion 320c2 of the spacer 320c and through the notch 320b3 and the notches 320b4 formed on the side plate portion 320b2 of the spacer 320b arranged adjacent to the spacer 320c.

In the power source pack 1 having the above-mentioned configuration, the container body 10 corresponds to the housing body in the present invention, and the battery 320a corresponds to the energy storage device in the present invention.

Further, the first electrical component subunit 30b corresponds to the first subunit in the present invention, the relay 30b4, the resistor 30b5, the bus bar 30b6, and the harness 30b7 correspond to the first electrical component in the present invention. The second electrical component subunit 20a corresponds to the second subunit in the present invention, the BMU 20a1, the fuse 20a2, and the communication connector 20a3 correspond to the second electrical component in the present invention.

The power source pack 1 of the first embodiment having such a configuration is characterized in that the cell stack 32, the first electrical component subunit 30b and the second electrical component subunit 20a, which the power source module body 30 and the lid portion 20 respectively include, are stacked in this order from the bottom to the top.

That is, the BMU and other electrical components which are operated in a cooperative manner with the cell stack 32 are stacked above the bus bar assembly unit 33 of the power source module body 30, while the bus bar assembly unit 33 is arranged in parallel to an X-Y plane in the drawing. With such a configuration, restriction imposed on shapes and sizes of the housing and the cell stack can be suppressed to a minimum level so that electrical components can be efficiently assembled into the housing whereby productivity of the power source packs can be enhanced.

Further, according to the first embodiment, the electrical connection between the cell stack 32 and the bus bar assembly unit 33 in the power source module body 30 and the first electrical component subunit 30b is established by fixing these members to each other using the bolt 30b1, the bolt 30b2 and the mounting bolt 30b3.

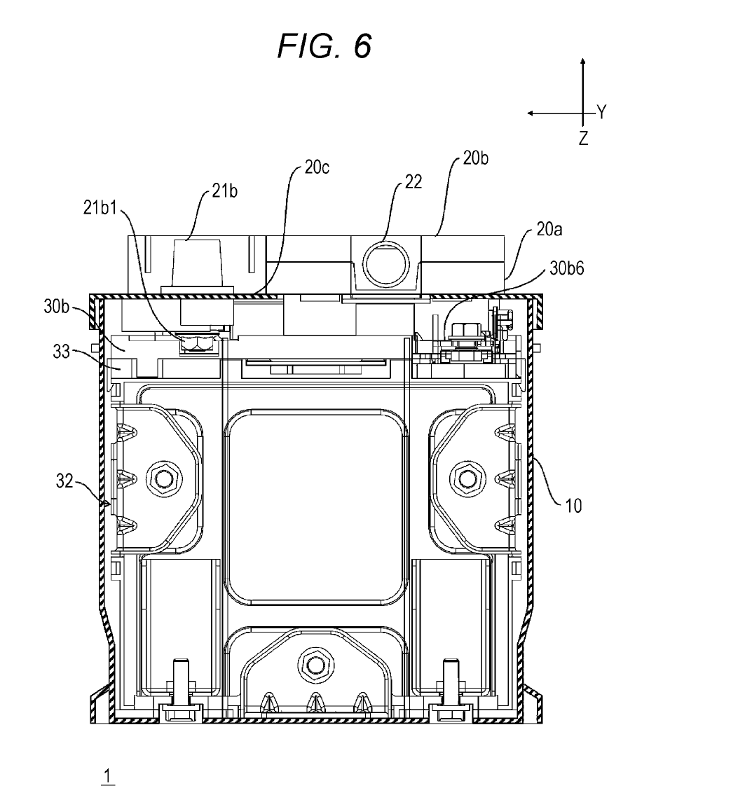

Similarly, as shown in FIG. 6 which is a partial cross-sectional view, the connection between the first electrical component subunit 30b and the second electrical component subunit 20a is established using a bolt 21b1 that connects an electrode terminal 21b and the first electrical component subunit 30b to each other (the same connection relationship being applied to the electrode terminal 21a positioned in a blind spot in the drawing). The connection between the harness 30b7 of the first electrical component subunit 30b and the communication connector 20a3 of the second electrical component subunit 20a and the BMU 20a1 is established through an opening formed in a region of the second electrical component subunit 20a inside the partition wall 20a4.

Concerning lines arranged between the cell stack 32, the first electrical component subunit 30b and the second electrical component subunit 20a, both the line forming a power path and the line forming a signal path are assembled in respective units (within respective planes) which are stacked. Accordingly, the lines are not exposed to a surface of the power source module body 30 which faces an inner wall of the housing in an opposed manner.

With such a configuration, the lines arranged between the BMU and other electrical components which are operated in a cooperative manner with the cell stack 32 are arranged without being restricted by positions, shapes, sizes and the like of the housing and the cell stack. Accordingly, the electrical components can be efficiently assembled into the housing and hence, productivity of the power source packs can be enhanced. Further, the lines are not routed around in the housing and hence, both a length of the power path and a length of the signal path can be shortened whereby the generation of heat, loss of electric power and the like can be suppressed. The power path and the signal path are not exposed to the housing and hence, a possibility that an impact from the outside is transmitted to the respective paths through the housing can be reduced.

The side surfaces of the cell stack 32 are only equipped with parts for maintaining the mechanical structure of the power source module body 30 such as the holder 32b and the like. Accordingly, a dead space in the container body 10 can be reduced thus miniaturizing the power source pack.

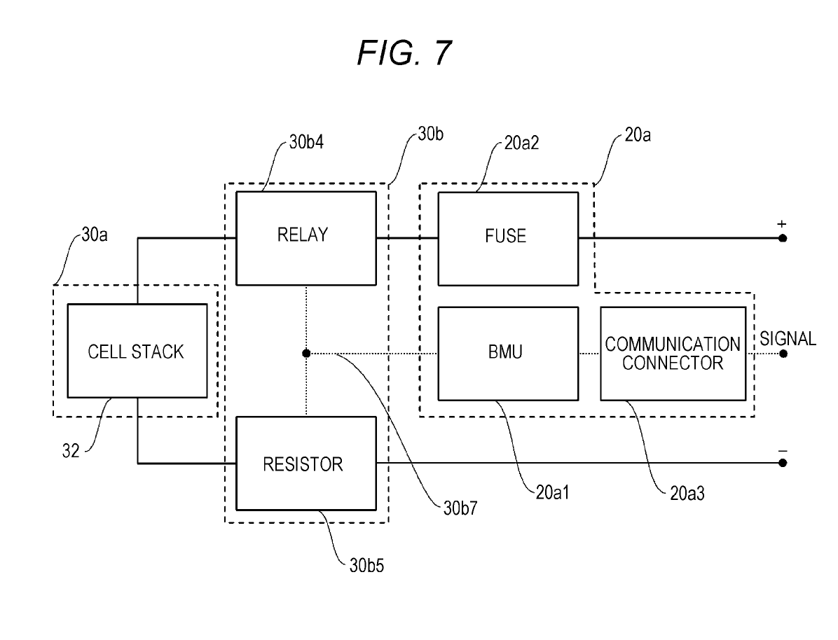

As shown in a block diagram in FIG. 7, the power source pack 1 of the first embodiment is assembled as follows. That is, the first electrical component subunit 30b is formed of: the relay 30b4 and the resistor 30b5 which are formed on the power path led out from the cell stack 32 which is a battery body; the bus bar 30b6 which forms the power path; and the harness 30b7 which forms a line for forming the signal path connected to the BMU 20a1. The second electrical component subunit 20a is formed of the fuse 20a2, the BMU 20a1 and the communication connector 20a3 which are formed on a power path led out from the cell stack 32. The respective assembled subunits are stacked on the cell stack 32 in order thus assembling the power source pack 1. With such a configuration, operability at the time of assembling the power source pack is enhanced so that productivity of the power source pack can be enhanced.

As shown in FIG. 6 which is a partial cross⁻sectional view, in the power source pack 1 of this first embodiment, the second electrical component subunit 20a closes a most part of the opening of the container body 10 as a portion of the lid portion 20, and the first electrical component subunit 30b which the power source module body 30 includes and the second electrical component subunit 20a which the lid portion 20 includes are substantially separated from each other by the bottom surface 20c of the lid portion 20. With such a configuration, an effect of radiant heat from the cell stack 32 or an effect of heat of exhaust gas generated from the safety valve 320a5 exerted on the second electrical component subunit 20a can be reduced, and the BMU 20a1 which is an electronic part is particularly protected from such heat. Accordingly, the reliability of the power source pack 1 can be enhanced.

The first electrical component subunit 30b is integrally formed with the power source module body 30 in the inside of the container body 10 which is closed by the lid portion 20. All of the relay 30b4, the resistor 30b5 and the bus bar 30b6 which are electrical components forming the first electrical component subunit 30b are less influenced by heat than the electrical components of the second electrical component subunit 20a.

In this manner, the power source pack 1 of the first embodiment is configured such that the cell stack 32, the first electrical component subunit 30b, and the second electrical component subunit 20a are stacked in this order from the bottom to the top. Accordingly, in addition to the above-mentioned advantageous effect, a thermal effect exerted on the electrical components of the power source pack can be reduced.

As shown in FIG. 7, the power source pack 1 of the first embodiment is configured as follows. The first electrical component subunit 30b is formed of: the relay 30b4 and the resistor 30b5 which are formed on the power path led out from the cell stack 32 which is a battery body; the bus bar 30b6 which forms the power path; and the harness 30b7 which forms a line for forming the signal path connected to the BMU 20a1. The second electrical component subunit 20a is formed of the fuse 20a2 which is formed on a power path led out from the cell stack 32, the BMU 20a1 and the communication connector 20a3. Accordingly, the power source pack 1 of the first embodiment can acquire the following advantageous effect. That is, the power source pack 1 is required to exhibit various functions, performances and the like corresponding to usage that a user uses the power source pack 1. To meet such a demand, it is necessary to combine the cell stack and various electrical components to each other. Conventionally, the designing and the manufacture of the power source pack 1 have been complicated or cumbersome.

According to this embodiment, the combination of electrical components can be prepared for the first electrical component subunit 30b and for the second electrical component subunit 20a respectively and separately and hence, the power source pack 1 can quickly cope with a demand of a user in the use of the power source pack 1. Further, while using the housing or the cell stack 32 in common, variations of functions of parts other than the housing and the cell stack 32 can be decided for the first electrical component subunit 30b and for the second electrical component subunit 20a respectively and separately. Accordingly, flexibility in designing the power source pack 1 can be enhanced.

Further, in the power source pack 1 of the first embodiment, the housing is formed of; the container body 10 which accommodates the cell stack 32 and the power source module body 30 including the first electrical component subunit 30b; and the lid portion 20 which incorporates the second electrical component subunit 20a therein. Further, the lid portion 20 is formed of the upper lid portion 20b provided with the exhaust sleeve 22, the panel 23a and the panel 23b. Accordingly, the power source pack 1 of the first embodiment can acquire the following advantageous effect. That is, the power source module body 30 can be completed in a state where the power source module body 30 is incorporated into the container body 10 in advance, and the lid portion 20 can be completed in a state where the lid portion 20 is incorporated in the second electrical component subunit 20a in advance. Accordingly, independence of the respective parts of the power source pack 1 can be enhanced. With such a configuration, steps of manufacturing the respective parts can be clearly distinguished from each other so that manufacturing efficiency of power source packs 1 can be enhanced.

In the lid portion 20, the upper lid portion 20b can be mounted on the second electrical component subunit 20a after the container body 10 is closed by the second electrical component subunit 20a. Accordingly, the harness 30b7 can be mounted between the first electrical component subunit 30b and the second electrical component subunit 20a with high operability so that manufacturing efficiency can be enhanced.

The panel 23a and the panel 23b both of which are detachable from the upper lid portion 20b are formed on the upper lid portion 20b so that an access to the second electrical component subunit 20a is facilitated. Accordingly, an electrical component such as the fuse 20a2 or the like can be easily exchanged so that the maintenance of the power source pack 1 can be simplified.

In the above-mentioned description, the first electrical component subunit 30b is formed of; the relay 30b4 and the resistor 30b5 both of which are formed on the power path led out from the cell stack 32 which is a battery body; the bus bar 30b6 forming the power path; and the harness 30b7 which is a line for forming the signal path connected to the BMU 20a1. Further, the second electrical component subunit 20a is formed of the fuse 20a2 which is formed on the power path led out from the cell stack 32, the BMU 20a1 and the communication connector 20a3. However, it is sufficient for the power source pack to have the configuration where the second subunit which includes the second electrical component is stacked on the first subunit which includes the first electrical component, and the power source pack according to the present invention is not limited by specific kinds, functions or the like of the respective electrical components.

The second electrical component incorporated in the lid portion and is easily accessible from the outside has relatively higher chances of maintenance than the first electrical component. Accordingly, it is desirable that the second electrical component be an electrical component which is replaced with high frequency. It is desirable that the second electrical component include at least a power path for the cell stack or a fuse relating to the operation of the BMU. To facilitate the inspection and maintenance of the second electrical component, the second electrical component may include at least the BMU.

The second electrical component is less affected by heat generated by the operation of the cell stack than the first electrical component. Accordingly, it is desirable that the second electrical component be an electrical component having low heat resistance. In this case, it is desirable that the second electrical component include at least a BMU or a communication connector.

The first electrical component accommodated in the housing and forms the first subunit positioned closer to the cell stack has relatively lower chances of maintenance than the second electrical component. Accordingly, as shown in FIG. 7, it is more desirable that the first electrical component be an electrical component which is arranged on the power path of the cell stack or an electrical component whose maintenance or replacement is performed with relatively low frequency. It is desirable that the first electrical component be at least a resistor or a switch (including a switching transistor) such as the relay 30b4.

### Second Embodiment

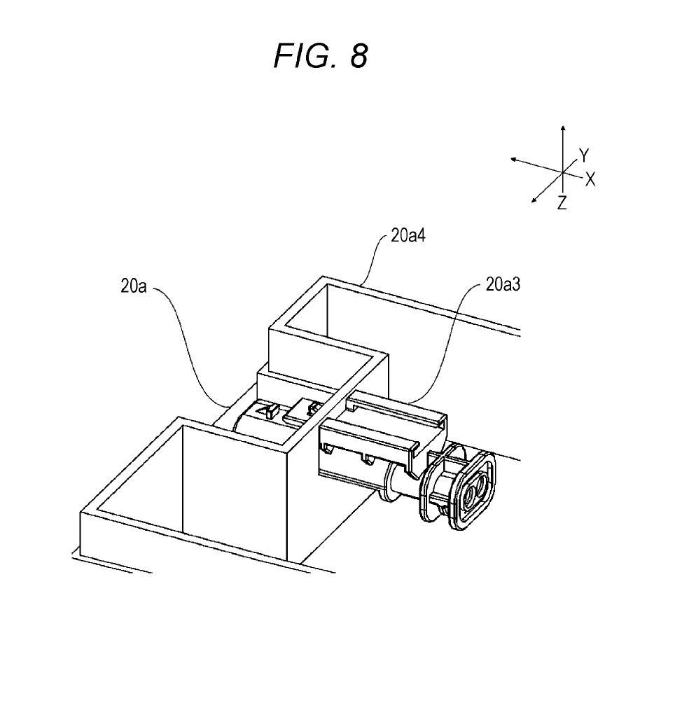

FIG. 8 is a perspective view, with a part enlarged, schematically showing a configuration of the power source pack 2 of a second embodiment of the present invention. In this embodiment, the components which are identical to or correspond to the components shown in FIG. 1 to FIG. 7 are given the same symbols, and the detailed description of such components is omitted. As shown in FIG. 8, the power source pack 2 of the second embodiment is characterized by the configuration where a communication connector 20a3 which forms a second electrical component is embedded in a partition wall 20a4 of a second electrical component subunit 20a which forms a part of a lid portion 20 of a housing. In the drawing, a harness which connects the communication connector 20a3 to other electrical components is omitted. The communication connector 20a3 corresponds to the connector in the present invention.

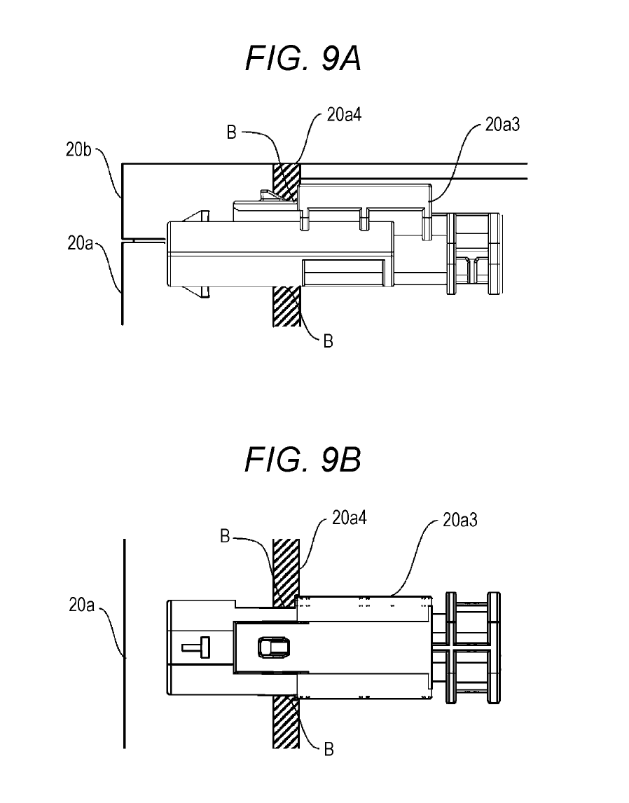

In this specification, “embedded” means a state where a surface of the communication connector 20a3 and a surface of the partition wall 20a4 formed of a single base member which is formed as a part of a base member of the second electrical component subunit 20a are brought into face contact with each other with no other member interposed therebetween or with no gap formed therebetween thus forming a boundary surface B. That is, “embedded” means a state where, as illustrated in FIG. 9A which is a cross-sectional view taken along a Z-Y plane in FIG. 3 and in FIG. 9B which is a cross-sectional view taken along a X-Y plane in FIG. 3, the communication connector 20a3 is fixedly mounted on the partition wall 20a4 with no gap therebetween so that both the communication connector 20a3 and the partition wall 20a4 cannot be separated from each other without breaking either one of the partition wall 20a4 or the communication connector 20a3.

The power source pack 1 of the second embodiment having such a configuration can acquire the following advantageous effects. The housing of the power source pack is required to be waterproof; however, the periphery of the communication connector, which is required to expose both ends thereof inside and outside the housing, has difficulty in this regard.

The communication connector has a specified shape stipulated in the standard. In fixing the communication connector to the housing such as the lid portion 20, to follow the specified shape of the communication connector, it is necessary to fill a gap with a filler for waterproofing or it is necessary to fit or fasten an additional part or the like into a gap so as to prevent the formation of the gap. Such a technique, however, brings about the increase of the number of steps of manufacturing a power source pack and the increase of a cost. Further, the presence of the filler or the additional member per se lowers a strength of the housing so that there is a possibility that reliability of the power source pack is lowered.

The lid portion 20 and the container body 10 may be fixed to each other by thermal welding. In this case, however, there is a possibility that the lid portion 20 is deformed by being affected by heat so that a gap is liable to be easily formed around the connector.

In view of the above, the second embodiment adopts the configuration where the communication connector 20a3 is embedded in the partition wall 20a4 as described above. With such a configuration, waterproofness can be ensured at a connecting portion between the communication connector 20a3 and the lid portion 20 and hence, the reliability of the power source pack can be enhanced.

The communication connector 20a3 may be embedded into the lid portion 20 by the following method. In case of forming a base member of the second electrical component subunit 20a by injection molding, the communication connector 20a3 can be fixed at a position where the partition wall 20a4 is to be formed by insert molding. On the other hand, in case of forming a base member of the second electrical component subunit 20a by a shaping device such as a so-called 3D printer, the base member can be formed into a shape of a partition wall 20a4 around the communication connector 20a3 using a filament (synthetic resin).

It is sufficient that the communication connector is fixed to the housing in a state where the communication connector is embedded in a portion of the housing, and the present invention is not limited to specific techniques for embedding the communication connector into the housing.

In the above-mentioned description, the communication connector 20a3 is selected as a member to be embedded into the lid portion 20. However, provided that the connector is connected to the power source module accommodated in the housing and is fixed to the housing, the connector in the present invention is not limited by usage and a kind of the connector. As one example, the connector may be a connector having an interface which corresponds to an in-vehicle network such as LIN or CAN or other desired protocols.

In the above-mentioned description, the connector is embedded in the lid portion 20. However, the connector may be embedded in the container body 10, the housing or the like at a desired position.

The present invention may be embodied in the form of the power source pack 1 having the configuration in the first embodiment. However, the present invention may be realized in the form of a power source pack having a desired configuration. That is, it is sufficient for the power source pack to have the configuration where the power source pack includes: a housing; a power source module body housed in the housing; and a connector connected to the power source module body, and the connector is fixed to the housing in a state where the connector is embedded in the housing. The present invention is not limited by specific configurations of other parts of the power source pack.

In the above-mentioned respective embodiments, the housing is the container having a rectangular parallelepiped profile and is formed of the container body 10 and the lid portion 20 both of which are made of a synthetic resin. However, the housing may be made of metal, other materials or the combination of these materials. The housing may be formed by combining three or more members together. Further, a profile of the housing may be a cubic shape, a cylindrical shape or a polygonal columnar shape. That is, the housing is not limited with respect to a shape, a specific material and the configuration thereof. However, it is effective to form the respective parts by injection molding from a viewpoint of mass production, the reduction of weight and resistance against impact. Accordingly, it is desirable to form the respective parts by injection molding. The exhaust sleeve 22 mounted on the housing is an example of the exhaust port. However, provided that the exhaust port allows the communication between the outside and the inside of the housing, a shape, a size and the like of the exhaust port may be desirably set, and the shape of the exhaust port is not limited to the shape of the cylindrical exhaust sleeve 22 of this embodiment. As one example, the exhaust port may be an opening which is formed in a wall body with a least height (length). In the above-mentioned respective embodiments, the energy storage devices used as the batteries for forming the cell stack are nonaqueous electrolyte secondary batteries represented by lithium ion secondary batteries. However, provided that the energy storage devices are batteries which can be charged and discharged by an electrochemical reaction, nickel-metal hydride batteries or other kinds of secondary batteries may be also used as the energy storage devices. Primary batteries may be used as the energy storage devices. Further, electric double layer capacitors or other kinds of capacitors may be used as the energy storage devices. That is, provided that the energy storage device of the present invention is an element which is formed by sealing an electrode assembly and an electrolyte solution in a storage container and can store electricity therein, the energy storage device of the present invention is not limited with respect to a specific method for generating an electromotive force.

That is, the present invention may be carried out in the form that various modifications are applied to the above-mentioned embodiments including the above-mentioned modifications without departing from the gist of the present invention.

The present invention having the above-mentioned configuration acquires an advantageous effect that a power source pack can enhance the productivity, and an advantageous effect that the power source pack is effectively applicable to a power source pack including energy storage devices such as secondary batteries, for example.

What is claimed is:

1. A power source pack comprising:
a housing;
a cell stack housed in the housing, the cell stack including an energy storage device;
a first subunit electrically connected to the cell stack, the first subunit including a first electrical component; and
a second subunit electrically connected to the first subunit, the second subunit including a second electrical component,
wherein the cell stack, the first subunit and the second subunit are stacked in a first direction.

2. The power source pack according to claim 1, wherein the first electrical component has higher heat resistance than the second electrical component.

3. The power source pack according to claim 1, wherein the housing includes a lid portion in which the second subunit is accommodated, and a housing body in which the cell stack and the first subunit are accommodated, and
a portion of the lid portion is detachable from remaining portions of the lid portion.

4. The power source pack according to claim 1, further comprising a connector connected to at least either one of the first subunit or the second subunit,
wherein the connector is embedded in the housing.

5. The power source pack according to claim 1, wherein the first electrical component is at least any one of a relay, a resistor and a bus bar.
